(19) United States
(12) Patent Application Publication
(10) Pub. No.: US 2012/0150683 A1
(43) Pub. Date: Jun. 14, 2012

(54) AUTOMATIC SELECTION AT A SELF-SERVICE DISPENSING DEVICE

(76) Inventor: Russell HERRINGTON, Monroe, GA (US)

(21) Appl. No.: 12/963,699

(22) Filed: Dec. 9, 2010

(51) Int. Cl. G06Q 30/00; G06F 17/00

(52) U.S. Cl. 705/26.8; 700/237

(57) ABSTRACT

A method is provided to auto select items when purchasing or leasing items at a self-service dispensing device. A user submits preferences that indicate items that the user wishes to purchase or lease. These preferences may be stored locally at a self-service dispensing device or at a central database accessible by any self-service dispensing device by a network connection. When a user arrives at a self-service dispensing device, he identifies himself to the device. This may be by any sort of method, including by swiping a credit or debit card. Once the user is identified, the self-service dispensing device selects the top ranked selections of available inventory based upon the preferences of the user. The user may select the any of the selections offered by the self-service dispensing device. If the user selects any of the options, the self-service dispensing device dispenses the items selected and the transaction is completed.

### FIELD OF THE INVENTION

The present invention relates, generally, to self-service dispensing devices.

### BACKGROUND

The methods in which consumers purchase or obtains items continually evolves. This may be seen, for example, in the area of procuring media content for private use. As used herein, media content may refer to, but is not limited to, motion pictures, television programs, sporting events, music, video games, or concerts. With the widespread adoption of the VHS video cassette recorder, retailers opened whose sole purpose was to lease or sell media content to consumers at commercial retail locations. This continued with the adoption of the digital versatile disc (DVD) player and the Blu-ray™ disc player.

Leases and purchases of media content have since moved to alternate delivery methods. For example, a self-service media content dispensing device, such as a kiosk, offers users the advantages of a self-service device where the user operates and completes the transaction. For the service provider of the dispensing device, advantages are realized by operating a device with a small footprint and avoiding the overhead of a retail establishment. As these self-service dispensing devices become more popular, methods and techniques to improve the consumer experience with these self-service devices becomes more important.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### SUMMARY

A method is provided for allowing an automatic selection of items when purchasing or leasing items at a self-service dispensing device. Items may be, for example, media content stored on digital storage devices. However, items are not limited thereto and may include any type of item that may be dispensed from a self-service dispensing device. In an embodiment, a user submits preferences that indicate items that the user wishes to purchase or lease. These preferences may be stored locally at a self-service dispensing device or at a central database that may be accessed by any self-service dispensing device by a network connection.

When a user arrives at a media content dispensing device, he identifies himself to the device. This may be through any sort of authentication method, including, but not limited to, swiping a credit or debit card, presenting an identification token, or manually entering identification data. Once the user is identified, the self-service dispensing device selects the top ranked selections of available inventory based upon the preferences of the user. The user may select any of the selections offered by the self-service dispensing device or make an entirely new selection. If the user selects any of the options, the self-service dispensing device dispenses the items selected and the transaction is completed. The preferences of the user are updated to indicate that the particular item has previously been leased or purchased by the user.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block illustration of a system for providing automatic selection of items on a self-service dispensing device, according to an embodiment of the invention;

FIG. 2 is an illustration of a workflow for providing automatic selection of items on a self-service dispensing device, according to an embodiment of the invention; and

FIG. 3 is a block diagram of a system on which embodiments of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Methods and techniques are described to provide automatic selection of items at a self-service dispensing device. The self-service dispensing device is preferably a touch-based computing dispensing device, such as a self-service kiosk that a user may operate though a graphical user interface on a display, and performing selections by touching a particular icon or symbol on the screen. Other methods of selection may be employed such as depressing a particular button in proximity to the display or through the use of a mouse. Any method of operation for the kiosk may be used.

One issue that may be encountered at a self-service dispensing device is that users may continually browse what items are available, prolonging the time of the transaction and increasing the wait time for other users who wish to also use the device. By devising methods that helps a user make a selection more quickly, transaction times are decreased and the device may be available for use by more users.

The issue of lengthy browsing is often encountered at devices that dispense media content stored on digital media storage devices, including, but not limited to an SD card, a USB flash drive, a portable hard drive, a DVD, a Blu-ray™ disc, a CD, or a solid-state drive. Users may wish to view the newest releases and then search for other media content in a particular genre or other category before making any selection. By improving the selection process, this browsing time may be decreased leading to an improved customer experience by both the user performing the transaction and other users waiting to use the self-service dispensing device.

In an embodiment, prior to visiting a self-service dispensing device, a user may enter preference data for items in a ranked order queue, or “favorites list,” that may be accessed by the self-service dispensing device. The favorites list may be entered at the self-service dispensing device, a computer, or mobile device with the use of an application or webpage. The favorites list is then stored at a central database, or at the self-service dispensing device that a user specifies.

The user who previously entered a favorites list then may visit a self-service dispensing device that is able to access his favorites list. For example, the self-service dispensing device receives a request from a user when he arrives at the device to determine the identification of a user. In an embodiment, the user may indicate on the self-service dispensing device, prior to any user identification, that he wishes to use auto-selection. Identification may be performed using any method that is able to identify or authenticate a particular user, such as swiping a debit or credit card through a slot on the dispensing device, or entering a username and password. The self-service dispensing device, based upon the identification data presented, identifies the particular user. Once the user is identified, the self-service dispensing device accesses the favorites list of the particular user. The self-service dispensing device presents possible available selections for the user that are the highest ranked items in current available inventory at the self-service dispensing device. The order of the possible selections may be based solely on the rank order of the items on the favorites list or be based upon other factors as well.

A user may make a selection based upon the presented automatic selections offered by the dispensing device. If a selection is received from the user, the dispensing device dispenses the items selected to the user. The transaction may be quickly completed using the credit card or debit card initially swiped by the user, or using billing information previously presented by the user and stored as part of user profile data of the user. A user may also be given the option to enter a new method of payment. Once the transaction is completed, the user's profile data is updated to reflect that an item on the favorites list has been purchased or leased. The decreased browsing time for selection and quicker completion of the transaction leads to a better experience for the user and also increases the availability of the dispensing device for other users.

### User Provides Preferences for Item Selection

In an embodiment, a user who wishes to speed transaction at a self-service dispensing device, such as a kiosk that dispenses media content, may enter his preferences at the self-service dispensing device or remotely via a computer or any mobile device. If preferences are entered at a computer or mobile device, a mobile application may be used to submit the preference data or a website accessed on the Internet. A user may create a user profile and that user profile is associated with his stored preferences. In an embodiment, the user profile data may comprise any data that may be used to identify the user, financial data, and preference data entered by the user. In other embodiments, financial data may be segregated and stored remotely from the user profile data in order to enhance security of financial data of users. To create a user profile, a user might, for example, provide a username and password. In another example, a user may simply provide credit or debit card information or any other payment method data. Once the user profile is created, the user may enter preferences in order to create a ranked order of preferred items, or a favorites list. The favorites list may come in many forms. For example, the favorites list may be a list of titles of media content that the user wishes to lease or purchase. Under this circumstance, a user may enter each title separately and then indicate a numerical order in which he wishes to purchase or lease the item. The favorites list may be any number of items in length. The favorites list may be a single item, or be hundreds of titles long.

In an embodiment, the user may simply indicate preferences of genre or category, rather than individual titles in the favorites list. For example, the user might indicate that he is most interested in action-adventure media content and horror content. The user may also indicate, instead of simply a genre, that he wishes to view only the newest releases, or media content with a specific actor, writer, or director. Any types of categorization in which a user may select preferences may be entered by the user in order to complete the favorites list.

In an embodiment, the user profile data and the preference data (either stored in conjunction with the user profile data, or separately) may be stored locally at a self-service dispensing device used by the user. In another embodiment, the profile data and the preference data (either stored in conjunction with the user profile data, or separately) is stored at a central server. When a user approaches a self-service dispensing device and identifies himself, the dispensing device requests the user profile data and preference data from the central server through a network connection.

In an embodiment, to encourage the creation of a user profile and preferences, the operator of the self-service dispensing device may also offer promotions or discounts for users. Discounts may be offered for the creation of a favorites list. Promotions may also be offered if the user selects the auto-selection feature when visiting a self-service dispensing device.

In an embodiment, the preferences and items entered by the user may also be used to recommend other titles of similar genre or category. For example, a user might only enter a preference of a particular horror film, and a recommendation module may recommend a newly released horror film that is similar to the user. In an embodiment, preference data may be aggregated with that of other users to determine correlations. For example, a correlation module may determine that a user who rents the movie “Avatar” is very likely to also rent the movie “Inception.” Under this circumstance, the correlation module may add the recommended title of “Inception” if the user selected “Avatar” in their favorites list.

### Identifying a User

In an embodiment, the user may indicate on the self-service dispensing device, prior to presenting any user identification, that he wishes to use auto-selection. In an embodiment, the user who wishes to purchase or lease an item is identified in order to present automatic selections for the user. The user may be identified using a variety of methods. In an embodiment, a user may swipe a credit or debit card or any type of identification card at the self-serve dispensing device. The data received from the swiped card are used to identify the user.

In another embodiment, a user may be identified based upon a token. The token may take multiple forms. For example, the token may be an RFID attached to a customer loyalty card or a near field communication (NFC) tag in a mobile device. An antenna from the self-service dispensing device would receive the signal transmitted by the token to help identify the user. The signal may contain an identification number or identification data that enables the self-service dispensing device to identify the user.

In an embodiment, a user may scan or swipe an identification card for identification of the user to the system. For example, a loyalty card might have a bar code that is able to be scanned via an optical scanner. In another example, the loyalty card has a magnetic strip that might be swiped in order for information to be read from the loyalty card. Data on the identification card is used to identify the user.

In an embodiment, the user may self-identify based on entering a username or other type of identifier. For example, the user may enter a username or other identification data (e.g., telephone number, etc.) in order for the user to identify himself to the system. In an embodiment, cameras may be used to identify users by an optical or biometric scan. Any other type of method upon which identifying an individual may be used to perform identification.

In an embodiment, user identification may occur either locally at a self-service dispensing device or remotely through a server. The self-service dispensing device may store user identification data locally so that the user may be quickly identified once the identification data is received. The self-service dispensing device may also send the user identification data to a server to identify the user if the self-service dispensing device does not store any identification data or the user is not readily identified by the local self-service dispensing device (that may occur where a user has previously performed transactions at other kiosks but not at the currently used kiosk).

In an embodiment, a primary central database is accessed in order retrieve the user profile data and preference data for the particular user. When the user is identified, the identification data is sent to a central database from a self-service dispensing device via a network. Based upon the identification data, the central database transmits user profile data and preference data to the self-service dispensing device that made the request. The user profile data and preference data is then used to determine what items are displayed to a user as an auto-selection.

### Automatic Selection of Items

In an embodiment, once a user has been identified, a determination may be made of whether the user has a user profile and preference data (or, a favorites list). In an embodiment, if a favorites list is present and the user did not select the auto-select option upon arriving at the self-service dispensing device, the user may again be displayed an option of whether he wants items to be auto-selected. If he does select the option for auto-selection, then the self-service dispensing device determines what items on the favorites list is available in the current inventory of the self-service dispensing device. The self-service dispensing device then displays the highest ranked items of the favorites list that are available on the device. The number of items shown may vary from implementation to implementation. The user may select any of the available auto-selected items. Upon receiving the selections, the dispensing device provides the items to the user. The transaction is then completed using financial information presented earlier or stored on a user's profile. If the auto-selection option is not selected, the user is presented with non-auto-selected items and the user may select any item from any type of genre or category.

In an embodiment, the auto-selected items are chosen exclusively from the favorites list of the user, and then displayed to the user in the same ranked order as the favorites list, as long as the item is currently available. In an embodiment, the user may select to receive the top two available rentals or any other number of top rentals and quickly complete the transaction. The user may also select any of the auto-selected items that are available.

In an embodiment, the display of the auto-selected items may vary based upon factors other than an item's ranked number on the favorites list. For example, if the self-service dispensing device has a large inventory of a particular media content and very few or a single copy of a different title of media content, then the self-service dispensing machine may display the title of the media content with the large inventory available before another title of media content. This will allow a particular self-service dispensing device to maintain a wider selection of available inventory and potentially increase the number of transactions. In another example, content providers might pay a fee to the operator of the self-service dispensing device in order to encourage rental of a particular title of media content. The self-service dispensing device operator might preferentially display the particular title of media content ahead of other items that are ranked higher on the favorites list. Even though the display of items varies, the user makes the ultimate decision of whether to purchase or lease a particular item.

In an embodiment, auto-selection display may not only occur with favorites lists, but also be based at least in part upon previous transaction history of the user. Based upon the user's past lease or purchase history of items, correlations may be made with currently available inventory to offer the user items of particular interest if the user, for example, previously purchased items primarily from a particular genre, such as horror.

In an embodiment, other factors for display of auto-selection may also be based upon, including, but not limited to, particular characteristics of the user or the demographics of the user. For example, a user who is male and is in his early 30s might arrive at a kiosk and enter identification data. Based upon the demographics of the user (e.g., age, gender, etc.) and transaction details (e.g., geographic location of purchase/lease, time of day, day of year, other titles also purchased/leased, previous transaction data, etc.) films of a particular genre that are available for purchase or lease may be displayed to the user as an auto-selection.

In an embodiment, previous transaction data may be limited by considering transaction data only from the particular user. In another embodiment, previous transaction data may be considered in aggregate with the particular user and a subset of other users. A particular user may select a preference that all of the particular user's previous transactions data are to remain private. Under this circumstance, previous transaction data of an aggregate of users might be considered for auto-selection of items, but the particular user's previous transaction data is not used in any way.

In an embodiment, a minimum amount of transaction data may be required prior to the transaction data being used to display auto-selections for a particular user. For example, the operator may require that the user have at least two previous transactions in order to have adequate information to present auto-selected items. The amount of data or number of visits may vary from implementation to implementation.

In an embodiment, transaction data based on other characteristics may be used in order to present more auto-selected items. For example, if there are children that are identified, children's movies may be offered as an auto-selection. Items may be offered based on the age of the user or any other identifiable characteristic that may help in offered items.

### Completion of Transaction

In an embodiment, once a user selects the option for auto-selection, he is presented with a display of his auto-selected items. The user may select any of the auto-selected items and may also choose any items that are not among the auto-selected items. In another embodiment, the auto-selection option when selected may automatically select the top item or top two items available with no further selections made by the user. The self-service dispensing device completes the transaction by using financial data from the user. The financial data may be from the initial credit card or debit card that was swiped for identification. Additionally, financial data may be stored in the user's profile and may be accessed upon final selection by the user. In an embodiment, financial data may be stored separately from user profile data for improved security. Under this circumstance, financial data might be stored on a separate database or server and needs to be accessed separately from user profile data. The self-service dispensing device may also present the terms of the transaction to the user (e.g., rental price per day, automatic purchase if not returned within X days, etc.) prior to being charged for the items and the user must accept the terms before the device dispenses the items. When the financial transaction is completed, the self-service dispensing device dispenses the items to the user.

In an embodiment, when a user makes a lease or purchase, the transaction data from the order is stored and linked to the particular user. The transaction data may be aggregated with transaction of other users to find correlations or similar demographic data in order to find additional items that may be auto-selected. Aggregated transaction data may be used for users who do not yet have adequate transaction data or do not wish for their individual transaction data to be used.

In an embodiment, upon dispensing the items to the user, the favorites list of the user is updated to reflect that the items that are dispensed have been obtained by the user. The favorites list may remove the items entirely from the favorites list or update associated data with the item on the favorites list to indicate that the item has been leased by the user and should no longer be used in auto-selection for the particular user in the future.

### Illustrated Examples

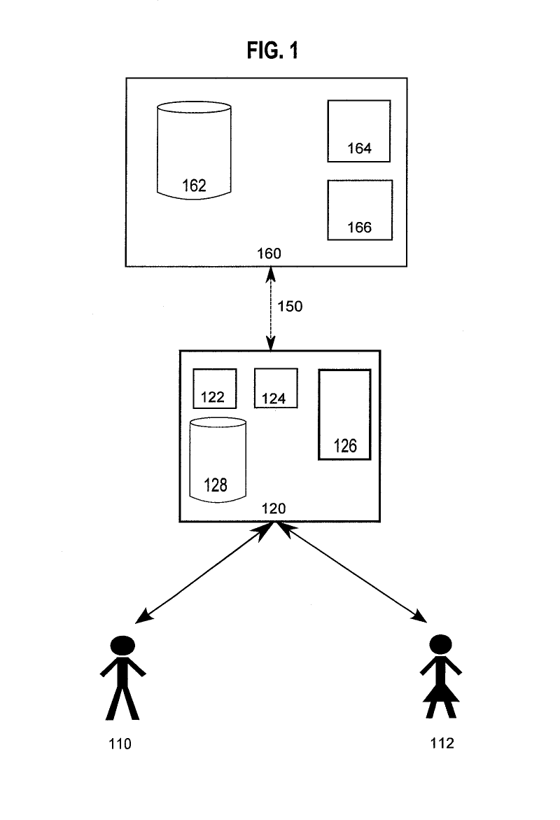

A system that is able to perform auto-selection of items on a self-service dispensing device is illustrated in FIG. 1. In FIG. 1, user 110 or user 112 may approach self-service dispensing device 120. User 110 and user 112 may have created a user profile and preference data by entering information at a home computer. Under this circumstance, the user profile and preference data is stored at remote server 160 that may be accessed by self-service dispensing device 120 via network connection 140. Network connection 140 may comprise a proprietary network or may include the Internet.

Remote server 160 comprises database storage 162. Database storage 162 may store user profile data, preference data, and/or financial data. All of the data may be stored on database storage 162 or each of the types of data may be stored on separate remote storage devices. Remote server may also comprise recommendation module 164 and correlation module 166 that is able to determine correlations based upon transaction data in order to provide items in an auto-selection display.

Self-service dispensing device 120 comprises display module 126 that displays to user 110 or user 112 menus or items that may be leased or purchased. Self-service dispensing device 120 is connected to remote server 160 via network connection 150. Self-service dispensing device 120 may also comprise storage 128 to store transaction data, user profile data, preference data, and/or financial data. Recommendation module 122 and correlation module 124 may determine items that may be shown to a user for auto-selections.

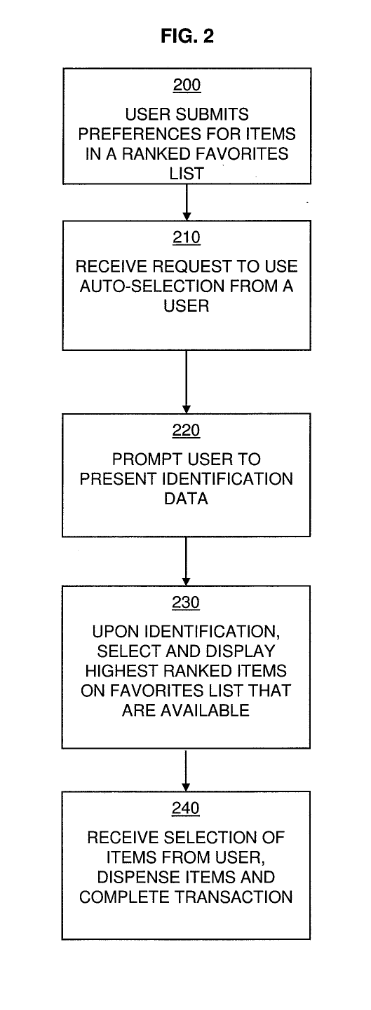

An illustration of the workflow for providing auto-selection of items in a self-service dispensing device is shown in FIG. 2. In step 200 of FIG. 2, a user may submit a preferences list in a user profile that lists a ranked order of items in the order that the user wishes to lease or purchase the items. In step 210, once arrived at a self-service dispensing device, the user selects the option to use auto-selection of items. In step 220, in response to the selection, the self-service dispensing device prompts the user to present user identification. The user presents identification and the self-service dispensing device displays the highest ranked items from the favorites list that are currently available on the dispensing device as shown in step 230. In step 240, the self-service dispensing device will receive the selection of items from the user. The self-service dispensing device may charge the credit or debit card of the user or use some other financial information from the user to complete the transaction. Once the user is charged, the self-service dispensing device dispenses the selected items to the user and is available for other users to operate.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

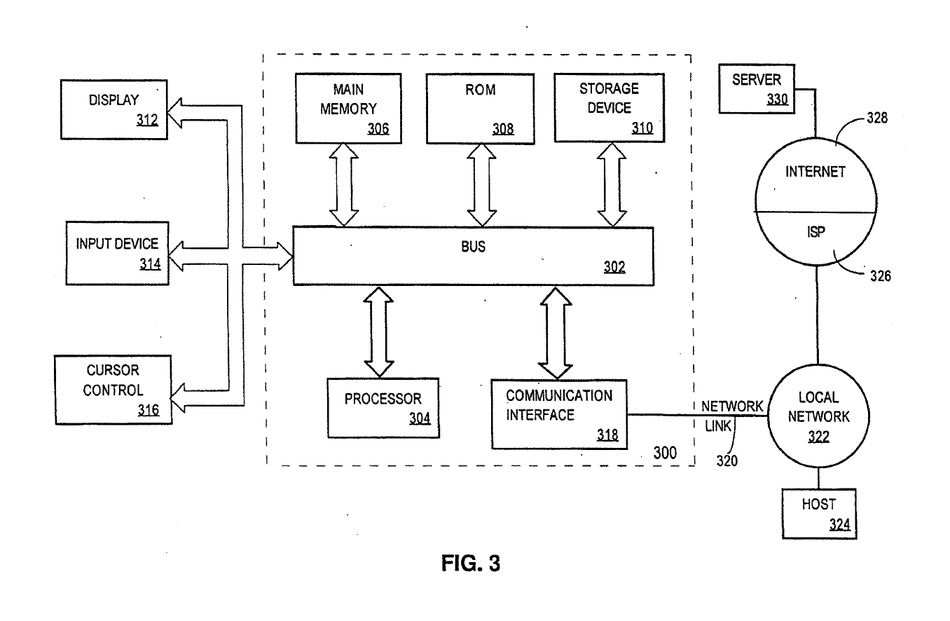

For example, FIG. 3 is a block diagram that illustrates a computer system 300 upon which an embodiment of the invention may be implemented. Computer system 300 includes a bus 302 or other communication mechanism for communicating information, and a hardware processor 304 coupled with bus 302 for processing information. Hardware processor 304 may be, for example, a general purpose microprocessor.

Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Such instructions, when stored in storage media accessible to processor 304, render computer system 300 into a special-purpose machine that is customized to perform the operations specified in the instructions.

Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

Computer system 300 may implement the techniques described herein using customized hard-wired logic, one or more ASICs or FPGAs, firmware and/or program logic which in combination with the computer system causes or programs computer system 300 to be a special-purpose machine. According to one embodiment, the techniques herein are performed by computer system 300 in response to processor 304 executing one or more sequences of one or more instructions contained in main memory 306. Such instructions may be read into main memory 306 from another storage medium, such as storage device 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any media that store data and/or instructions that cause a machine to operation in a specific fashion. Such storage media may comprise non-volatile media and/or volatile media. Non-volatile media includes, for example, optical or magnetic disks, such as storage device 310. Volatile media includes dynamic memory, such as main memory 306. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 302. Transmission media can also take the form of acoustic or light waves, such as those generated during radio-wave and infra-red data communications.

Various forms of media may be involved in carrying one or more sequences of one or more instructions to processor 304 for execution. For example, the instructions may initially be carried on a magnetic disk or solid state drive of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card, cable modem, satellite modem, or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are example forms of transmission media.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method comprising:
receiving a request from a user to purchase media content;
determining an identity of the user;
determining whether the user has a ranked list of media indicating preferences of the user;
upon determining that the user has a ranked list of media content, searching available inventory to find the highest ranked media content available;
displaying, to the user, the highest ranked media content available;
receiving a request that the user has selected the at least one of the highest ranked media content available;
delivering the selected media content to the user,
wherein the method is performed by one or more special-purpose computing devices.

2. The method of claim 1, further comprising receiving, from the user, a request to display items using auto-selection.

3. The method of claim 1, wherein the media content includes motion pictures, television programs, sporting events, music, video games, or concerts.

4. The method of claim 1, wherein the ranked list of media content is based on preferences previously indicated by the user.

5. The method of claim 1, wherein the ranked list of media content is based at least in part on previous transaction data of the user.

6. The method of claim 1, wherein the ranked list of media content is based at least in part on previous transaction data of an aggregate of users.

7. The method of claim 1, wherein the media content is stored on transportable digital storage devices.

8. The method of claim 7, wherein transportable digital storage devices comprise at least one of: an SD card, a USB flash drive, a portable hard drive, a DVD, a Blu-ray™ disc, a CD, or a solid-state drive.

9. One or more storage media storing instructions which, when executed by one or more computing devices, cause performance of the method recited in claim 1.

10. A system comprising:
a plurality of self-service dispensing devices; and
a server;
a particular self-service dispensing device of the plurality of self-service dispensing devices receives identification data that indicates a particular user;
the particular self-service dispensing device identifies a user based on the identification data;
the particular self-service dispensing device transmits a request to the server for user profile data indicating a ranked order list of items based upon the user;
the server transmitting user profile data to the kiosk that provides layout of the user interface and items displayed on the user interface of the kiosk; and
upon determining that the user has a ranked list of media content, the particular self-service dispensing device searching available inventory to find the highest ranked media content available;
the particular self-service dispensing device displaying, to the user, the highest ranked media content available;
the particular self-service dispensing device receiving a request that the user has selected the at least one of the highest ranked media content available;
the particular self-service dispensing device delivering the selected media content to the user.

11. The system of claim 10, wherein the items are media content.

12. The system of claim 11, wherein the ranked list of media content is based on preferences previously indicated by the user.

13. The system of claim 11, wherein the media content is stored on transportable digital storage devices.

14. The system of claim 13, wherein transportable digital storage devices comprise at least one of: an SD card, a USB flash drive, a portable hard drive, a DVD, a Blu-ray™ disc, a CD, or a solid-state drive.

15. A method comprising:
receiving a request from a user to purchase an item;
determining an identity of the user;
determining whether the user has a ranked list of items indicating preferences of the user;
upon determining that the user has a ranked list of items, searching available inventory to find the highest ranked items available;
displaying, to the user, the highest ranked items available;
receiving a request that the user has selected the at least one of the highest ranked items available;
delivering the selected item to the user,
wherein the method is performed by one or more special-purpose computing devices.

16. One or more storage media storing instructions which, when executed by one or more computing devices, cause performance of the method recited in claim 15.
